(19) United States
(12) Patent Application Publication
(10) Pub. No.: US 2020/0276611 A1
(43) Pub. Date: Sep. 3, 2020

(54) Two-Component Moisture Curable Composition

(71) Applicant: Kaneka Americas Holding, Inc., Pasadena, TX (US)

(72) Inventors: Ruolei Wang, Pasadena, TX (US); Kenneth Sutherland, Pasadena, TX (US)

(73) Assignee: Kaneka Americas Holding, Inc., Pasadena, TX (US)

(21) Appl. No.: 16/804,606

(22) Filed: Feb. 28, 2020

Related U.S. Application Data
(60) Provisional application No. 62/812,646, filed on Mar. 1, 2019.

(51) Int. Cl. B05D 7/00; B05D 7/14

(52) U.S. Cl. CPC B05D 7/548; B05D 7/14; B05D 2504/00; B05D 2518/10; B05D 2503/00; B05D 2202/00; B05D 2203/30; B05D 2502/00; B05D 2320/00

(57) ABSTRACT

A two-component moisture curable composition, a membrane system including the same, and a structure including the same are disclosed herein. In some embodiments, a structure includes a substrate, and a membrane system disposed on the substrate, wherein the membrane system comprises a single layer prepared from a two-component moisture curable composition comprising a reactive organic polymer containing a reactive silyl function group and an epoxy resin, wherein the single layer functions as a primer and a base coat, the single layer disposed on the substrate, and a top coat disposed on the single layer on a surface of the single layer opposite that of the substrate. The moisture curable composition can be applied directly to an adhesion-resistant substrate without the higher number of application steps and/or other chemical treatment required with conventional compositions.

### CROSS-REFERENCE TO RELATED APPLICATIONS

The present application claims priority from U.S. Provisional Patent Application No. 62/812,646, filed Mar. 1, 2019, the disclosure of which is incorporated by reference herein.

### FIELD OF THE INVENTION

A moisture curable composition, a membrane system including the same, and a structure including the same are disclosed herein. The present disclosure is generally related to improved membrane systems for the covering of structures, and more particularly to a membrane system including a two-component moisture curable composition (hereinafter “two-component system” or “2K System” or “curable composition”) useable as a primer that can adhere directly to the substrate of such a structure. The curable composition includes a reactive organic polymer containing reactive silyl function group(s) and an epoxy resin, and maintains equal or superior characteristics to those of a typical membrane system, including adhesion of the moisture curable composition to the substrate, allowance for flexibility of movement of the underlying structure, and durability of the overall membrane system.

### BACKGROUND

Typically, a membrane system used for the protection of a structure has contained a number of layers, including a primer, a basecoat, a top coat and (optionally) a finish coat or other additional coat(s). The basecoat is a layer that allows for the membrane system to expand and contract to accommodate movement of the underlying substrate, while the primer is a layer that allows for adhesion directly to the surface of such a structure.

FIG. 1 depicts a conventional membrane system 100 for protection of a structure (substrate 102) in accordance with the prior art. The membrane system 100 has multiple layers, including a primer 104, a basecoat 106, and a top coat 108. A finish coat or other additional layers would be optional (not shown in FIG. 1).

The current technology requires multiple application steps during installation of the membrane system. Significant benefits can be achieved if the number of layers in the membrane system is reduced, yet no current formulations allow for combination of the basecoat and primer layers into a single layer within the membrane system while maintaining equal or superior characteristics like adhesion, flexibility, and durability.

The present invention provides a two-component system that includes a reactive organic polymer containing reactive silyl function group(s) and an epoxy resin. This two-component system allows for application of the composition directly to a substrate, without the application of a multiple-coating process or other chemical treatment required by traditional compositions, while maintaining sufficient adhesion to the underlying substrate and allowing for flexibility of movement of the underlying structure.

### BRIEF SUMMARY OF INVENTION

A moisture curable composition, a membrane system including the same, and a structure including the same are disclosed herein.

In some embodiments, a two-component moisture curable composition comprises a reactive organic polymer containing a reactive silyl function group and an epoxy resin.

In some embodiments, structure includes a substrate, and a membrane system disposed on the substrate, wherein the membrane system comprises a single layer prepared from a two-component moisture curable composition comprising a reactive organic polymer containing a reactive silyl function group and an epoxy resin, wherein the single layer functions as a primer and a base coat, the single layer disposed on the substrate, and a top coat disposed on the single layer on a surface of the single layer opposite that of the substrate.

In some embodiments, a membrane system for application to a substrate, includes a single layer configured to attach to a surface of a substrate, the single layer prepared from a two-component moisture curable composition comprising a reactive organic polymer containing a reactive silyl function group and an epoxy resin, wherein the single layer functions as a primer and a base coat, and a top coat disposed on the single layer on a surface of the single layer opposite that of the surface of the single layer configured to be disposed on the substrate.

### BRIEF DESCRIPTION OF THE DRAWINGS

FIG. 1 is a perspective view of a cross-sectional portion of a conventional membrane system in accordance with the prior art.

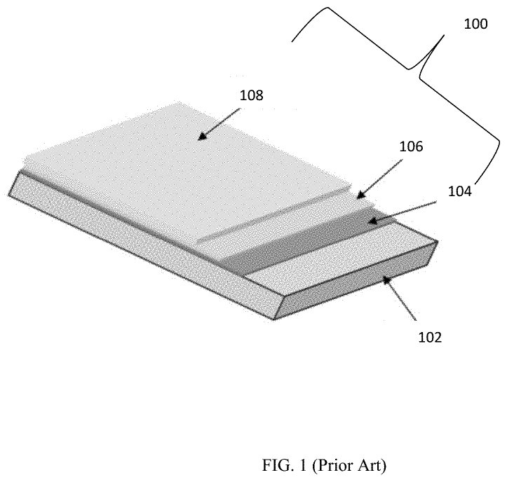

FIG. 2 is a perspective view of a cross-sectional portion of a membrane system in accordance with the present disclosure.

Aspects of the present disclosure are best understood from the following detailed description when read with the accompanying figures. It is noted that, in accordance with the standard practice in the industry, various features are not drawn to scale.

### DETAILED DESCRIPTION

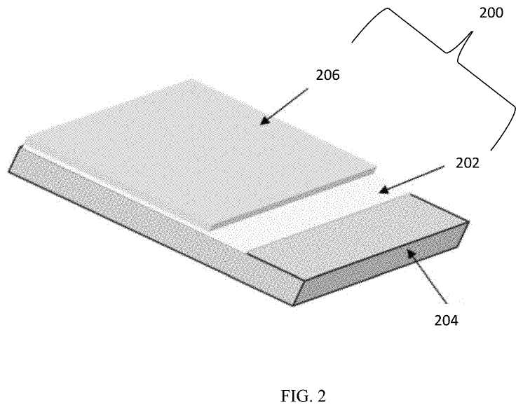

A two-component moisture curable composition, a membrane system including the same, and a structure including the same are disclosed herein. FIG. 2 depicts a membrane system 200 in accordance with the present disclosure. The membrane system 200, in contrast to the conventional membrane system 100, combines the basecoat and primer layers into a single layer, thus providing a combined-layer system. The membrane system 200 includes a single layer 202 prepared from a two-component moisture curable composition, where the single layer functions as a basecoat and a primer. The composition 202 is disposed on a structure (substrate 204). The membrane system 200 further includes a top coat 206 disposed on an opposite surface of the composition 202 to the substrate 204. Additional and intervening layers, such as a finish coat and other layers may be included.

The curable composition 202 includes an organic polymer containing a reactive silyl functional group(s), and an epoxy resin. In some embodiments, the epoxy resin may be present in about 30-70 parts by weight, relative to 100 parts by weight of the organic polymer.

An exemplary organic polymer may contain reactive silicon groups represented by the following general formula (1):

—Si(R¹₃₋ₐ)Xₐ (1)

wherein R¹ represents an alkyl group having 1 to 20 carbon atoms, an aryl group having 6 to 20 carbon atoms, or an aralkyl group having 7 to 20 carbon atoms,

X represents a hydrolyzable group, wherein each X may be the same or different when provided that when two or more Xs are present, they may be the same or different, and

a represents 1, 2 or 3,

provided that when a is 1, each R¹ may be the same or different and

provided that when a is 2 or 3, each X may be the same or different;

In some embodiments, X represents —OR, wherein R is an alkyl group having 1 to 2 carbon atoms.

The organic polymer containing reactive silicon groups are commercially available and/or can be prepared in accordance with techniques known in the art. Examples of polymer containing reactive silicon groups include but are not limited to silyl-terminated polyether and silane-terminated polyurethane. More specific examples of commercially available polymer=containing reactive silicon groups include but are not limited to KANEKA MS POLYMER® S327, KANEKA MS POLYMER® S227, KANEKA MS POLYMER® S203H, KANEKA SILYL® SAX220, KANEKA SILYL® SAX350, and combinations thereof.

The curable composition will be described on the basis of the following examples; however, the invention is not limited to these examples. In these examples, the reactive organic polymer containing reactive silyl functional group(s) that is used in the two-component moisture curable composition is Kaneka MS Polymer®; however, it is understood that alternative embodiments may involve the use of other reactive organic polymers containing reactive silyl functional group(s).

In some embodiments, the curable composition includes two parts, a Part A and a Part B. Part A may include the organic polymer containing reactive silyl functional group, a dehydration agent, a hardener, an adhesion promoter, and, optionally, a filler. Part B may include the epoxy resin, a catalyst, and water.

In some embodiments, Part A, which is a curable compound, may include a moisture-reactive silylated polymer, e.g., an organic polymer including a reactive silyl functional group(s), a curing curative, and a silane couple agent. In some embodiments, a filler and/or a pigment may also be present in Part A.

In some embodiments, Part B may include an epoxy resin, a catalyst, and water. An alternative of Part B may include a plasticizer, a portion of the aforementioned moisture-reactive silylated polymer, an epoxy resin, a catalyst, a water scavenger, and optionally a filler and/or pigment.

The membrane system utilizing two-component curable moisture composition can be customized to work with a topcoat, finish coat, and/or additional layers that may be chosen to provide sufficient flexibility and durability performance.

Returning to FIG. 2, the top coat 206 can include materials such as polyurethane, epoxy, polyurea, methyl methacrylate, and combinations thereof. Exemplary top coat materials include Elasto-Deck 5000 H.T., which is a polyurethane based material, available from Pacific Polymers (PU); Iso-Flex 750 Top Coat, which is a polyurethane-based material, available from Lymtal; MARK-170.2 Flexodeck II, which is an epoxy-based material, available from Poly-Carl), Inc.; and Hyperlast EMH 95A, which a polyurea-based material available from Dow Chemical, Inc.

Overlying the top coat 206 can be a finished coat (not shown in FIG. 2). The finish coat can be, for example, a liquid applied membrane with hard hardness (shore D>D60) that can provide uniform aesthetic, UV resistance and abrasion resistance. The finish coat can include polyurea, polyurethane, epoxy, polyester and/or polyacrylate.

The substrate 204 may be one or more of concrete, steel deck, or other metal substrates. The substrate 204 may be part of a structure, such as a parking deck, observation deck, a stadium, bridge overlay, or the like.

In some embodiments, a method of applying a liquid two-component moisture curable composition is provided, wherein the method may include applying a moisture-reactive silylated polymer-based primer system to a substrate, where the primer system includes one or more moisture curable polymers with reactive silyl groups, one or more epoxy resins, and one or more curing curatives. The composition can optionally be made uniform on the substrate, for example, by backrolling with a roller or other apparatus used to make the thickness of a deposited composition more uniform.

In some embodiments, the moisture-reactive silylated polymer having reactive silyl groups may be crosslinked by forming siloxane bond group(s), is a polyacrylate having reactive silyl groups, a polyether having reactive silyl groups, or a polyurethane having reactive silyl groups.

In some embodiments, the epoxy resin may be present in about 30-70 parts by weight, relative to 100 parts by weight of the moisture-reactive silylated polymers. In some embodiments, the curing curatives may be present in about 2-20 parts by weight to 100 parts by weight of the moisture-reactive silylated polymers.

In some embodiments, the curing curative does not have the primary amino function group in the structure. In other embodiments, the curing curative may be a tertiary amine.

In some embodiments, the curable composition may include a catalyst for promoting fast reaction among the reactive silyl groups of the polymer having reactive silyl groups.

In some embodiments, the curable composition may include a silane coupling agent as an adhesion promoter.

In some embodiments, the curable composition may include a plasticizer, a water scavenger, such as, for example, an amino silane, a filler, such as, for example, calcium carbonate and the like, and various clay minerals known to those in the art, and a pigment, such as, for example, TiO₂, carbon black, various organic pigments, and other pigments known to those of skill in the art.

In some embodiments, the curable composition may be applied to any surface of a substrate directly, such as a surface without additional chemical treatment, or a surface having a preexisting liquid applied membrane, such as epoxy, acrylic, silyl terminated polyether, polyester, or polyurethane membrane.

In some embodiments, the curable composition may be applied to a substrate and cured to form a film having sufficient bond strength to the substrate, and provide adequate flexibility to handle structure movement.

In some embodiments, the present disclosure provides a coating system that includes applying a coat of moisture curable primer composition on at least a part of the substrate, and a coat of a second coating composition (e.g. a top coat) on at least a part of the primer coat.

In some embodiments, the curable composition is substantially free of volatile organic compounds. In other embodiments, the composition is free of volatile organic compounds. In some embodiments, the composition is also free of carcinogens and volatile solvents.

In some embodiments, a method for preparing a substrate having a membrane system includes mixing a large volume of the above-described components of the curable composition until the components become homogenous. For example, a large volume may be about 28 gallons or greater. Homogenization make take about 3 to 5 minutes. The homogenized composition is poured onto a large area of a surface, for example, a deck surface of a parking structure. The poured composition can be spread at any suitable rate, for example, such as 50 square feet per gallon. Spreading can be initiated by a squeegee or other spreading device. Prior to becoming tacky, the poured and spread composition can be leveled or made uniform, for example, by backrolling with a roller or other suitable apparatus. Once the composition becomes tacky, a top coat can be applied. A typical area being coated by the curable composition can be about 10,000 to about 100,000 square feet.

It was found that use of the curable composition of the present disclosure improved elastomeric properties, improved flexibility and pliability, provided faster and deeper cure, provided thicker film buildup, and a low temperature cure, as compared with conventional compositions.

The curable composition, when cured, may provide a tensile strength of around 7 MPa and elongation of around about 300 percent or more, which is commensurate with the values of a typical basecoat known in the art. The curable composition also provides sufficient bonding ability and flexibility. Accordingly, the primer and basecoat layers can be replaced within a multi-layer membrane system by the curable composition of the present disclosure.

### EXAMPLES

In each of Examples 1-3, as shown in Table 1 below, the curable composition is made up of Parts A and B. Part A includes a reactive organic polymer containing reactive silyl function group (e.g., Kaneka MS Polymer®, Kaneka Silyl®), a dehydration agent (VTMO), a hardener (Ancamine K54), and an adhesion promoter; the adhesion promoter varies in each example (Example 1—DAMO-T, Example 2—Dyanslan 1146, and Example 3—SIVO 260). Part B includes an epoxy resin (EPON828), a catalyst (U-220H), and water.

TABLE 1
Formulations of Examples 1-3 and Resulting Properties

| | | Example 1 | Example 2 | Example 3 |
|---|---|---|---|---|
| Component | | | | |
| Part A | | | | |
| MS Polymer | SAX350 | 100 | 100 | 100 |
| Adhesion promoter | Dyanslan 1146 | | 2 | |
| | SIVO 260 | | | 2 |
| | DAMO-T | 2 | | |
| Hardener (for Epoxy) | Ancamine K54 | 5 | 5 | 5 |
| Total | | 107 | 107 | 107 |
| Part B | | | | |
| Epoxy Resin | EPON828 | 50 | 50 | 50 |
| Catalyst | U-220H | 2 | 2 | 2 |
| Water | H2O | 0.5 | 0.5 | 0.5 |
| Total | | 52.5 | 52.5 | 52.5 |
| Properties | | | | |
| Viscosity of Part A (cps) | | 5,000-7,000 | | |
| Viscosity of Part B (cps) | | 12,000-15,000 | | |
| Hardness (ASTM C661) | Shore A | 50 | 47 | 42 |
| Tensile properties by dumbbell | M100 (MPa) | 1.04 | 0.99 | 0.70 |
| shape (ASTM D412) | Tensile strength (MPa) | 7.80 | 7.90 | 7.77 |
| | % Elongation | 396 | 473 | 637 |

In each of Examples 4-6, the curable composition is made up of Parts A and B. Part A includes a reactive organic polymer containing reactive silyl function group (e.g., Kaneka MS Polymer®, Kaneka Silyl®), a dehydration agent (VTMO), an adhesion promoter (DAMO-T), a hardener (Ancamine K54), and an optional filler (Example 4—no filler, Example 5—UltraPflex, and Example 6—no filler). Part B includes an epoxy resin (EPON828), a catalyst (U-220H), and water.

TABLE 2
Formulations of Examples 4-6 and Resulting Properties

| | | Example 4 | Example 5 | Example 6 | Example 7 |
|---|---|---|---|---|---|
| Component | | | | | |
| Part A | | | | | |
| MS Polymer | SAX350 | 100 | 100 | 100 | 25 |
| | SAX750 | | | | 50 |
| Dehydration Agent | VTMO | | | | 2 |
| Adhesion promoter | DAMO-T | 2 | 4 | 4 | 5 |
| Hardener (for Epoxy) | Ancamine K54 | 5 | 5 | 10 | 10 |
| Filler | Q3T | | | | 45 |
| | UltraPflex | | 15 | | 25 |
| Pigment | TiO2 | | | | 10 |
| Thixtropic Agent | Cravylac SL | | | | 2 |
| Catalyst | U-220H | | | | 2 |
| Total | | 107 | 124 | 114 | 176 |
| Part B | | | | | |
| Epoxy Resin | EPON828 | 50 | 50 | 50 | 30 |
| | EPONEX1510 | | | | 15 |
| MS Polymer | SAX350 | | | | 25 |
| Plasticizer | DINP | | | | 15 |
| Thixotropic Agent | Crayvallac SL | | | | 2 |
| Catalyst | U-220H | 2 | 2 | 2 | |
| Filler | UltraPflex | | | | 15 |
| | Q3T | | | | 65 |
| Water | H2O | 0.5 | 0.5 | 0.5 | |
| Dehydration Agent | VTMO | | | | 1 |
| Total | | 52.5 | 52.5 | 52.5 | 168 |
| Properties | | | | | |
| Hardness (ASTM C661) | Shore A | 50 | 57 | 54 | 81 |
| Tensile properties by dumbbell | M100 (MPa) | 1.04 | 2.38 | 1.71 | 4.22 |
| shape (ASTM D412) | | | | | |
| | Tensile strength (MPa) | 7.80 | 7.13 | 11.11 | 7.30 |
| | % Elongation | 396 | 272 | 360 | 74 |
| Adhesion on concrete | Adhesion strength (psi) | 292 | 478 | 493 | N/A |
| | Failure mode | Concrete | Concrete | Concrete | N/A |
| | | failure | failure | failure | |

The curable composition provided significant improvement on wet adhesion retention over concrete surfaces. Using the ASTM C794/D903, 180° peel test, over a period of 12 months, with a target of greater than 5 pli, and full immersion in water, the following was observed:

TABLE 3
Wet Adhesion on a Concrete Surface
versus a single phase curable composition
Significant Improvement on Wet Adhesion
Retention Over Concrete Surface

Test Method: ASTM C794/D903, 180° peel
Exposure Period: 12 Months
Target: >5 pli
Water Exposure: Full immersion

| | | | Comparative | | |
|---|---|---|---|---|---|
| Wet Adhesion | | | example | Example 1 | Example 7 |
| Peel | Dry | pli | 69.3 | 99.4 | 82.6 |
| Strength | Wet | pli | 23.0 | 78.4 | 72.0 |
| | (7 Days) | | | | |
| | Wet | pli | 8.4 | 40.3 | 73.9 |
| | (6 WKs) | | | | |
| | Wet | pli | 4.5 | 32.5 | 44.8 |
| | (3 Months) | | | | |
| | Wet | pli | 3.4 | 30.8 | 50.4 |
| | (6 Months) | | | | |
| | Wet | pli | —* | 30.8 | 54.3 |
| | (12 Months) | | | | |

*Sample was extremely soft, fell apart in the container, and was unable to be tested.

The comparative example in Table 3 is a curable composition having a single component, moisture cure, silyl-terminated polymer based waterproofing membrane. Single component means that an epoxy resin was not added to the curable composition.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A structure, comprising:
a substrate; and
a membrane system disposed on the substrate, wherein the membrane system comprises:
a single layer prepared from a two-component moisture curable composition comprising a reactive organic polymer containing a reactive silyl function group and an epoxy resin, wherein the single layer functions as a primer and a base coat, the single layer disposed on the substrate; and
a top coat disposed on the single layer on a surface of the single layer opposite that of the substrate.

2. The structure of claim 1, wherein the reactive organic polymer is a cross-linking polymer forming a siloxane bond group.

3. The structure of claim 1, wherein the reactive organic polymer is a polyacrylate, a polyether, or a polyurethane.

4. The structure of claim 1, wherein the epoxy resin is present in about 30-70 parts by weight to 100 parts by weight of the reactive organic polymer.

5. The structure of claim 1, wherein the curable composition comprises a curing curative being present in about 2-20 parts by weight to 100 parts by weight of the reactive organic polymer.

6. The structure of claim 5, wherein the curing curative is a tertiary amine.

7. The structure of claim 1, wherein the curable composition comprises a catalyst for promoting fast reaction among the reactive silyl function group.

8. The structure of claim 1, wherein the curable composition comprises a silane coupling agent as an adhesion promoter.

9. The structure of claim 1, wherein the curable composition is free of volatile organic compounds.

10. The structure of claim 1, wherein the substrate comprises one or more of concrete or a metal substrate.

11. The structure of claim 1, wherein the top coat comprises one or more of polyurethane, epoxy, polyurea, or methyl methacrylate.

12. A membrane system for application to a substrate, comprising:
a single layer configured to attach to a surface of a substrate, the single layer prepared from a two-component moisture curable composition comprising a reactive organic polymer containing a reactive silyl function group and an epoxy resin, wherein the single layer functions as a primer and a base coat; and
a top coat disposed on the single layer on a surface of the single layer opposite that of the surface of the single layer configured to be disposed on the substrate.

13. The membrane system of claim 12, wherein the reactive organic polymer is a cross-linking polymer forming a siloxane bond group.

14. The membrane system of claim 12, wherein the reactive organic polymer is a polyacrylate, a polyether, or a polyurethane.

15. The membrane system of claim 12, wherein the epoxy resin is present in about 30-70 parts by weight to 100 parts by weight of the reactive organic polymer.

16. The membrane system of claim 12, wherein the curable composition comprises a curing curative being present in about 2-20 parts by weight to 100 parts by weight of the reactive organic polymer.

17. The membrane system of claim 16, wherein the curing curative is a tertiary amine.

18. The membrane system of claim 12, wherein the curable composition comprises a catalyst for promoting fast reaction among the reactive silyl function group.

19. The membrane system of claim 12, wherein the curable composition comprises a silane coupling agent as an adhesion promoter.

20. The membrane system of claim 12, wherein the top coat comprises one or more of polyurethane, epoxy, polyurea, or methyl methacrylate.
